(19) United States
(12) Patent Application Publication
(10) Pub. No.: US 2023/0274557 A1
(43) Pub. Date: Aug. 31, 2023

(54) METHOD FOR DETERMINING LINE PRESSING STATE OF A VEHICLE, ELECTRONIC DEVICE, AND NON-TRANSITORY COMPUTER-READABLE STORAGE MEDIUM

(71) Applicant: Apollo Intelligent Connectivity (Beijing) Technology Co., Ltd., Beijing (CN)

(72) Inventors: Gaosheng LIU, Beijing (CN); Shaogeng LIU, Beijing (CN); Wenyao CHE, Beijing (CN)

(73) Assignee: Apollo Intelligent Connectivity (Beijing) Technology Co., Ltd., Beijing (CN)

(21) Appl. No.: 18/174,581

(22) Filed: Feb. 24, 2023

(30) Foreign Application Priority Data
Feb. 25, 2022 (CN) 202210179342.9

(51) Int. Cl. G06V 20/56; G06V 10/44; G06T 7/70

(52) U.S. Cl. CPC G06V 20/588; G06V 10/443; G06T 7/70; G06T 2207/30252

(57) ABSTRACT

Provided are a method for determining a line pressing state of a vehicle, an electronic device, and a non-transitory computer-readable storage medium. The specific scheme is that: a vehicle type of a target vehicle in a to-be-recognized image and a visible wheel region where a visible wheel of the target vehicle in the to-be-recognized image is located are determined, a blocked wheel region where a blocked wheel of the target vehicle in the to-be-recognized image is located is determined according to the vehicle type and the visible wheel region, and a line pressing state of the target vehicle is determined according to the visible wheel region and the blocked wheel region.

### CROSS-REFERENCE TO RELATED APPLICATION

This application claims priority to Chinese Patent Application No. 202210179342.9 filed Feb. 25, 2022, the disclosure of which is incorporated herein by reference in its entirety.

### TECHNICAL FIELD

The present disclosure relates to the field of image processing technology and, in particular, to the fields of intelligent transportation technology, cloud computing technology and cloud service technology, especially a method for determining the line pressing state of a vehicle, an electronic device, and a non-transitory computer-readable storage medium.

### BACKGROUND

With the improvement of living standards, the number of private cars has been increasing, raising the number of vehicles running on the road. In the field of intelligent transportation, how to determine whether a vehicle has a line pressing violation based on a collected image has become a critical topic.

Currently, the determination of whether a vehicle presses a line is mainly dependent on determining a wheel position of the vehicle in a manual review manner.

### SUMMARY

The present disclosure provides a method for determining a line pressing state of a vehicle, an electronic device, and a non-transitory computer-readable storage medium.

According to an aspect of the present disclosure, a method for determining a line pressing state of a vehicle is provided. The method includes the following.

A vehicle type of a target vehicle in a to-be-recognized image and a visible wheel region where a visible wheel of the target vehicle in the to-be-recognized image is located are determined.

A blocked wheel region where a blocked wheel of the target vehicle in the to-be-recognized image is located is determined according to the vehicle type and the visible wheel region.

A line pressing state of the target vehicle is determined according to the visible wheel region and the blocked wheel region.

According to another aspect of the present disclosure, an electronic device is provided. The electronic device includes at least one processor and a memory communicatively connected to the at least one processor.

The memory stores an instruction executable by the at least one processor. The instruction is executed by the at least one processor to cause the at least one processor to perform: determining a vehicle type of a target vehicle in a to-be-recognized image and a visible wheel region where a visible wheel of the target vehicle in the to-be-recognized image is located; determining, according to the vehicle type and the visible wheel region, a blocked wheel region where a blocked wheel of the target vehicle in the to-be-recognized image is located; and determining a line pressing state of the target vehicle according to the visible wheel region and the blocked wheel region.

According to another aspect of the present disclosure, a non-transitory computer-readable storage medium is provided. The storage medium stores a computer instruction, and the computer instruction is configured to cause a computer to perform: determining a vehicle type of a target vehicle in a to-be-recognized image and a visible wheel region where a visible wheel of the target vehicle in the to-be-recognized image is located; determining, according to the vehicle type and the visible wheel region, a blocked wheel region where a blocked wheel of the target vehicle in the to-be-recognized image is located; and determining a line pressing state of the target vehicle according to the visible wheel region and the blocked wheel region.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a flowchart of a method for determining a line pressing state of a vehicle according to an embodiment of the present disclosure.

FIG. 2 is a flowchart of another method for determining a line pressing state of a vehicle according to an embodiment of the present disclosure.

FIG. 3 is a diagram illustrating the structure of an apparatus for determining a line pressing state of a vehicle according to an embodiment of the present disclosure.

FIG. 4 is a block diagram of an electronic device for performing a method for determining a line pressing state of a vehicle according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, the description of well-known functions and constructions is omitted hereinafter for clarity and conciseness.

The determination of a line pressing state of a vehicle is performed in a manual manner currently. That is, an inspector determines, according to a wheel position of a vehicle in a collected image and a lane line position in the collected image, whether the vehicle presses a line. However, a camera used for collecting the image has a certain shooting angle. Thus not all wheels of the vehicle in the collected image are visible. The inspector may perform a line pressing determination according to only the position of a visible wheel. In a current method, the inspector cannot perform the line pressing determination according to a blocked wheel, resulting in a relatively low accuracy of determining the line pressing state of the vehicle.

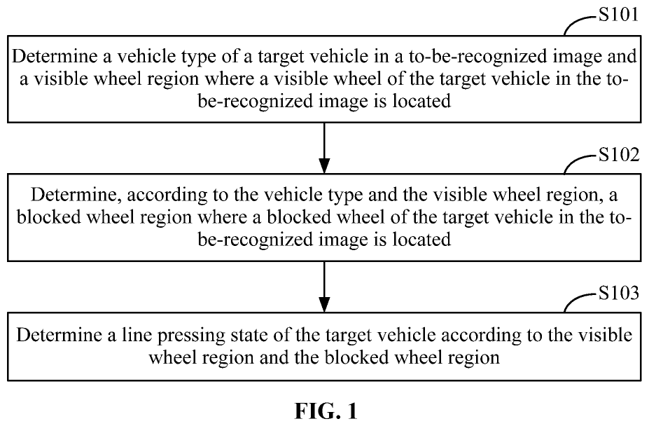

FIG. 1 is a flowchart of a method for determining a line pressing state of a vehicle according to an embodiment of the present disclosure. This embodiment may be applied to the case of determining whether a target vehicle has a line pressing violation. The method in this embodiment may be performed by an apparatus for determining a line pressing state of a vehicle according to an embodiment of the present disclosure. The apparatus may be implemented by software and/or hardware and integrated in any electronic device having a computing capability.

As shown in FIG. 1, the method for determining a line pressing state of a vehicle according to this embodiment may include the following.

In S101, a vehicle type of a target vehicle in a to-be-recognized image and a visible wheel region where a visible wheel of the target vehicle in the to-be-recognized image is located are determined.

The to-be-recognized image is collected and obtained by an image collection device arranged in a road region. The road region includes, but is not limited to, a highway, an urban road, an expressway, or a national highway. This embodiment does not limit the road region to which the to-be-recognized image belongs. The image collection device includes, but is not limited to, a video camera or a camera. When the image collection device is a video camera, the to-be-recognized image is a video frame in a video sequence. When the image collection device is a camera, the to-be-recognized image is an image frame captured periodically.

The vehicle type represents a type to which the target vehicle belongs. For example, the vehicle type of the target vehicle may represent the vehicle category to which the target vehicle belongs, for example, a car, a sport utility vehicle (SUV), a multi-purpose vehicle (MPV), a truck, or a passenger car. The vehicle type may be further divided into, for example, a compact car, a mid-size car, a full-size car, a compact SUV, a mid-size SUV, or a full-size SUV. In another example, the vehicle type of the target vehicle may further represent the specific type of the target vehicle, for example, vehicle type B launched by brand A in 2010. The specific content of the vehicle type may be set according to actual business requirements.

Due to the existence of a shooting angle of the image collection device, wheels of the target vehicle are divided into at least one visible wheel and at least one blocked wheel. A visible wheel represents a wheel that can be directly recognized through a recognition algorithm in the to-be-recognized image of the target vehicle. One or more visible wheels may exist. A blocked wheel represents a wheel that cannot be recognized through a recognition algorithm in the to-be-recognized image of the target vehicle due to the block of the vehicle body. The visible wheel region represents a pixel set occupied by a visible wheel in the to-be-recognized image.

In an implementation, video flow data collected by the image collection device is acquired, and at least one video frame is extracted from the video flow data and taken as the to-be-recognized image. A target detection is performed on the to-be-recognized image by using a target detection model to recognize at least one target vehicle in the to-be-recognized image and the vehicle type of each target vehicle. The target detection model includes a deep learning model. The generation manner of the target detection model is as follows: For a sample image, each vehicle position and each vehicle type are labeled manually; the manually labeled sample image is taken as a training data set; and model training is performed on the training data set to obtain the target detection model in this embodiment.

Further, a wheel region in the to-be-recognized image is recognized by using a wheel recognition model to determine the visible wheel region of a visible wheel of a target vehicle in the to-be-recognized image. The generation manner of the wheel recognition module is as follows: The visible wheel region of a vehicle in a sample image is labeled manually; the manually labeled sample image is taken as a training data set; and model training is performed on the training data set to obtain the wheel recognition model in this embodiment.

The vehicle type of the target vehicle in the to-be-recognized image and the visible wheel region where the visible wheel of the target vehicle in the to-be-recognized image is located are determined, which lays a data foundation for the subsequent determination of a blocked wheel region according to the vehicle type and the visible wheel region, guaranteeing that the method is performed smoothly.

In S102, a blocked wheel region where a blocked wheel of the target vehicle in the to-be-recognized image is located is determined according to the vehicle type and the visible wheel region.

One or more blocked wheels may exist. The blocked wheel region represents a pixel set occupied by a predicted blocked wheel in the to-be-recognized image.

In an implementation, each vehicle type and each vehicle attribute are stored in a vehicle attribute database as a key—value (KV) pair. That is, an associated vehicle attribute Value is matched according to any vehicle type Key. A vehicle attribute includes the physical attribute information of a vehicle, for example, vehicle length information, vehicle height information, vehicle weight information, vehicle width information, wheel relative positions, and wheel relative poses.

The attribute of the target vehicle matching the vehicle type of the target vehicle is determined by matching the vehicle type of the target vehicle in the vehicle attribute database. Moreover, wheel relative positions of the target vehicle and wheel relative poses of the target vehicle are determined from the attribute of the target vehicle. A wheel relative position represents a wheel distance between wheels of the target vehicle in the world coordinate system. A wheel relative pose represents a relative pose formed by each wheel of the target vehicle in the world coordinate system.

The wheel relative positions of the target vehicle in the to-be-recognized image and the wheel relative poses of the target vehicle in the to-be-recognized image are determined according to wheel relative positions in the world coordinate system, wheel relative poses in the world coordinate system, and a camera parameter of a target camera for collecting the to-be-recognized image. Further, the blocked wheel region of the blocked wheel in the to-be-recognized image is predicted and obtained according to the recognized visible wheel region, wheel relative positions in the to-be-recognized image, and wheel relative poses in the to-be-recognized image.

The blocked wheel region of the blocked wheel of the target vehicle in the to-be-recognized image is determined according to the vehicle type and the visible wheel region, which implements the prediction of the blocked wheel region, avoids the problem that the blocked wheel region cannot be determined in a manual manner in the related art, and further improves the accuracy of determining a line pressing state of the target vehicle subsequently.

In S103, a line pressing state of the target vehicle is determined according to the visible wheel region and the blocked wheel region.

In an implementation, a lane line detection is performed on the to-be-recognized image to determine a lane line region in the to-be-recognized image. The visible wheel region and the blocked wheel region are each matched with the lane line region. If coordinates have an intersection, it is determined that the line pressing state of the target vehicle is a line pressed state. If coordinates have no intersection, it is determined that the line pressing state of the target vehicle is a line non-pressed state.

In the present disclosure, the vehicle type of the target vehicle in the to-be-recognized image and the visible wheel region where the visible wheel of the target vehicle in the to-be-recognized image is located are determined, and the blocked wheel region where the blocked wheel of the target vehicle in the to-be-recognized image is located is determined according to the vehicle type and the visible wheel region. Accordingly, the blocked wheel region is predicted, and the effect that a line pressing determination is performed according to both the visible wheel region and the blocked wheel region is implemented. The problem that a line pressing determination is performed according to only the visible wheel region in an existing manual manner is avoided, thereby greatly improving the accuracy of determining the line pressing state. Moreover, no new image collection device needs to be re-deployed, thereby saving costs.

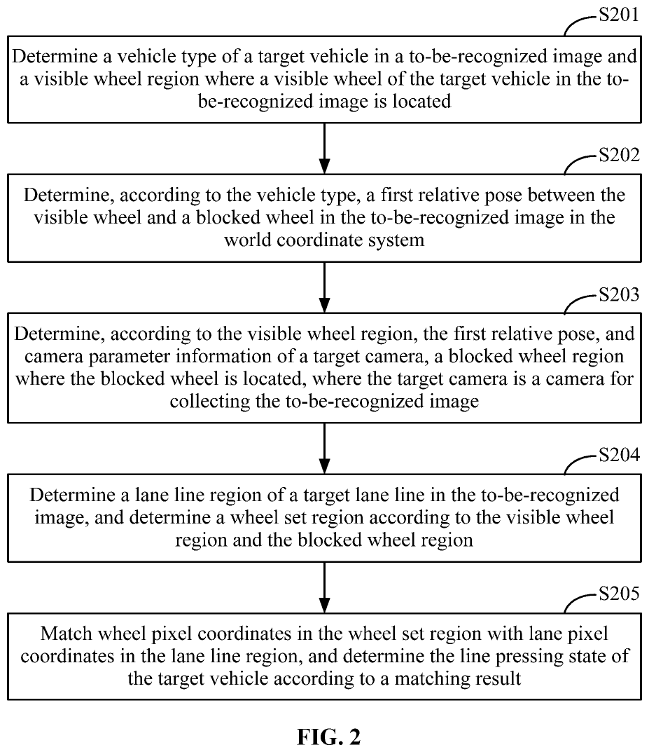

FIG. 2 is a flowchart of another method for determining a line pressing state of a vehicle according to an embodiment of the present disclosure. This method is further optimized and extended based on the preceding technical scheme and may be combined with the preceding various optional implementations.

As shown in FIG. 2, the method for determining a line pressing state of a vehicle according to this embodiment may include the following.

In S201, a vehicle type of a target vehicle in a to-be-recognized image and a visible wheel region where a visible wheel of the target vehicle in the to-be-recognized image is located are determined.

In S202, a first relative pose between the visible wheel and a blocked wheel in the to-be-recognized image in the world coordinate system is determined according to the vehicle type.

The first relative pose includes a first relative position and a first relative attitude.

In an implementation, the attribute of the target vehicle matching the vehicle type of the target vehicle is determined by matching the vehicle type of the target vehicle in the vehicle attribute database, and wheel relative positions of the target vehicle and wheel relative poses of the target vehicle are determined from the attribute of the target vehicle. Further, the first relative position between the visible wheel and the blocked wheel is determined according to the wheel relative positions of the target vehicle, and the first relative attitude between the visible wheel and the blocked wheel is determined according to the wheel relative attitudes of the target vehicle.

In S203, a blocked wheel region where the blocked wheel is located is determined according to the visible wheel region, the first relative pose, and camera parameter information of a target camera. The target camera is a camera for collecting the to-be-recognized image.

The camera parameter information includes a cameral extrinsic parameter and a camera intrinsic parameter. The camera intrinsic parameter includes, but is not limited to, the focal length of the target camera, a coordinate of the imaging principal point, and a distortion parameter. The camera extrinsic parameter includes the position of the target camera in the world coordinate system and the attitude of the target camera in the world coordinate system. The camera parameter information may be predetermined by calibrating the target camera.

In an implementation, the conversion of a relative pose is performed according to the first relative pose and the camera parameter information. The first relative pose in the world coordinate system is converted to a second relative pose in an image coordinate system. Further, the blocked wheel region is determined according to the second relative pose and the visible wheel region.

In an embodiment, S203 includes step A and step B.

In step A, a second relative pose between the visible wheel and the blocked wheel in the to-be-recognized image is determined according to the camera parameter information and the first relative pose.

The second relative pose represents a second relative position between the visible wheel and the blocked wheel and a second relative attitude between the visible wheel and the blocked wheel in the image coordinate system of the to-be-recognized image.

In an implementation, in the case where the camera parameter information and the first relative pose are known, the second relative pose is determined according to the equation relationship among the camera parameter information, the first relative pose, and the second pose.

In an embodiment, step A includes the following.

A matrix product between the camera parameter information and the first relative pose is determined, and the second relative pose is determined according to the matrix product.

In an implementation, the second relative pose is determined according to the formula below.

[X2]=[M][N][X1]

[M] denotes the matrix representation of a camera intrinsic parameter in the camera parameter information. [N] denotes the matrix representation of a camera extrinsic parameter in the camera parameter information. [X1] denotes the matrix representation of the first relative pose. [X2] denotes the matrix representation of the second relative pose.

The matrix product between the camera intrinsic parameter and the first relative pose and the matrix product between the camera extrinsic parameter and the first relative pose are calculated and are taken as the second relative pose.

The matrix product between the camera parameter information and the first relative pose is determined, and the second relative pose is determined according to the matrix product. With this arrangement, the effect that the relative pose between the visible wheel and the blocked wheel in the world coordinate system is converted to the relative pose in the image coordinate system is implemented, laying a data foundation for the subsequent prediction of the blocked wheel region in the to-be-recognized image.

In step B, the blocked wheel region is determined according to the second relative pose and the visible wheel region.

In an implementation, a regional translation is performed on the visible wheel region in the to-be-recognized image according to the second relative pose. The translated visible wheel region is taken as the blocked wheel region.

The second relative pose between the visible wheel and the blocked wheel in the to-be-recognized image is determined according to the camera parameter information and the first relative pose, and the blocked wheel region is determined according to the second relative pose and the visible wheel region. With this arrangement, the effect of predicting the blocked wheel region is implemented, avoiding the problem that a line pressing determination is performed according to only the visible wheel region in an existing manual manner.

In S204, a lane line region of a target lane line in the to-be-recognized image is determined, and a wheel set region is determined according to the visible wheel region and the blocked wheel region.

In an implementation, a grayscale transformation is performed on the to-be-recognized image to generate a grayscale image corresponding to the to-be-recognized image. Gaussian filtering is performed on the grayscale image to generate a filtered image corresponding to the grayscale image. Further, an edge detection is performed on the filtered image, and a region of interest is determined according to an edge detection result. Finally, the lane line region in the to-be-recognized image is determined according to the region of interest.

A region union of the visible wheel region and the blocked wheel region is determined and is taken as the wheel set region.

In S205, wheel pixel coordinates in the wheel set region are matched with lane pixel coordinates in the lane line region, and the line pressing state of the target vehicle is determined according to a matching result.

In an implementation, a pixel in the wheel set region is taken as a wheel pixel, and a pixel in the lane line region is taken as a lane pixel. Wheel pixel coordinates and lane pixel coordinates are traversed for matching to determine whether matched pixel coordinates exist. Further, the line pressing state of the target vehicle is determined according to the matching result.

In an embodiment, S205 includes the following.

In the case where at least one wheel pixel coordinate matches a lane pixel coordinate, it is determined that the line pressing state of the target vehicle is the line pressed state. In the case where no wheel pixel coordinate matches a lane pixel coordinate, it is determined that the line pressing state of the target vehicle is the line non-pressed state.

In an implementation, if at least one wheel pixel coordinate matches a lane pixel coordinate, it indicates that the visible wheel of the target vehicle or the blocked wheel of the target vehicle encroaches on the lane line. Further, it is determined that the line pressing state of the target vehicle is the line pressed state. If no wheel pixel coordinate matches a lane pixel coordinate, it indicates that the visible wheel of the target vehicle or the blocked wheel of the target vehicle does not encroach on the lane line. Further, it is determined that the line pressing state of the target vehicle is the line non-pressed state.

In the case where at least one wheel pixel coordinate matches a lane pixel coordinate, it is determined that the line pressing state of the target vehicle is the line pressed state. With this arrangement, the effect of automatically determining the line pressing state of a vehicle is implemented with no manual participation, reducing labor costs and improving accuracy.

In the present disclosure, the first relative pose between the visible wheel and the blocked wheel in the world coordinate system is determined according to the vehicle type; and the blocked wheel region is determined according to the visible wheel region, the first relative pose, and the camera parameter information of the target camera. With this arrangement, the effect of predicting the blocked wheel region is implemented, avoiding the problem that a line pressing determination is performed according to only the visible wheel region in an existing manual manner. The lane line region of the target lane line in the to-be-recognized image is determined, and the wheel set region is determined according to the visible wheel region and the blocked wheel region; further, the wheel pixel coordinates in the wheel set region are matched with the lane pixel coordinates in the lane line region, and the line pressing state of the target vehicle is determined according to the matching result. Accordingly, the effect that a line pressing determination is performed according to both the visible wheel region and the blocked wheel region is implemented, avoiding the problem that a line pressing determination is performed according to only the visible wheel region in an existing manual manner. Moreover, the effect of automatically determining the line pressing state of a vehicle is implemented with no manual participation, reducing labor costs and improving accuracy.

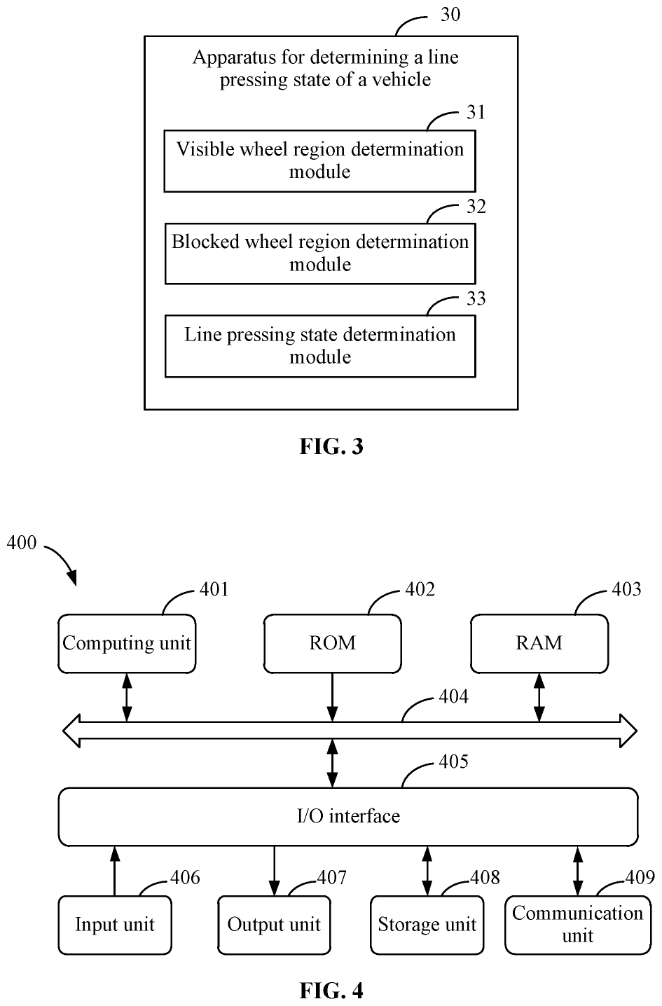

FIG. 3 is a diagram illustrating the structure of an apparatus for determining a line pressing state of a vehicle according to an embodiment of the present disclosure. This embodiment may be applied to the case of determining whether a target vehicle has a line pressing violation. The apparatus in this embodiment may be implemented by software and/or hardware and integrated in any electronic device having a computing capability.

As shown in FIG. 3, as disclosed in this embodiment, the apparatus 30 for determining a line pressing state of a vehicle may include a visible wheel region determination module 31, a blocked wheel region determination module 32, and a line pressing state determination module 33.

The visible wheel region determination module 31 is configured to determine a vehicle type of a target vehicle in a to-be-recognized image and a visible wheel region where a visible wheel of the target vehicle in the to-be-recognized image is located.

The blocked wheel region determination module 32 is configured to determine, according to the vehicle type and the visible wheel region, a blocked wheel region where a blocked wheel of the target vehicle in the to-be-recognized image is located.

The line pressing state determination module 33 is configured to determine a line pressing state of the target vehicle according to the visible wheel region and the blocked wheel region.

In an embodiment, the blocked wheel region determination module 32 is configured to determine a first relative pose between the visible wheel and the blocked wheel in the world coordinate system according to the vehicle type; and determine the blocked wheel region where the blocked wheel is located according to the visible wheel region, the first relative pose, and camera parameter information of a target camera. The target camera is a camera for collecting the to-be-recognized image.

In an embodiment, the blocked wheel region determination module 32 is further configured to determine a second relative pose between the visible wheel and the blocked wheel in the to-be-recognized image is determined according to the camera parameter information and the first relative pose; and determine the blocked wheel region according to the second relative pose and the visible wheel region.

In an embodiment, the blocked wheel region determination module 32 is further configured to determine a matrix product between the camera parameter information and the first relative pose, and determine the second relative pose according to the matrix product.

In an embodiment, the line pressing state determination module 33 is configured to determine a lane line region of a target lane line in the to-be-recognized image, and determine a wheel set region according to the visible wheel region and the blocked wheel region; and match wheel pixel coordinates in the wheel set region with lane pixel coordinates in the lane line region, and determine the line pressing state of the target vehicle according to a matching result.

In an embodiment, the line pressing state determination module 33 is further configured to in the case where at least one wheel pixel coordinate matches a lane pixel coordinate, determine that the line pressing state of the target vehicle is a line pressed state.

The apparatus 30 for determining a line pressing state of a vehicle in embodiments of the present disclosure may perform the method for determining the line pressing state of a vehicle in embodiments of the present disclosure and has function modules and beneficial effects corresponding to the performed method. For content not described in detail in this embodiment, reference may be made to the description in method embodiments of the present disclosure.

Operations, including acquisition, storage, and application, on a user's personal information involved in the technical schemes of the present disclosure conform to relevant laws and regulations and do not violate the public policy doctrine.

According to embodiments of the present disclosure, the present disclosure further provides an electronic device, a readable storage medium, and a computer program product.

FIG. 4 is a block diagram of an electronic device 400 for performing a method for determining a line pressing state of a vehicle according to an embodiment of the present disclosure. The electronic device is intended to represent various forms of digital computers, for example, a laptop computer, a desktop computer, a worktable, a personal digital assistant, a server, a blade server, a mainframe computer, or another applicable computer. The electronic device may also represent various forms of mobile apparatuses, for example, a personal digital assistant, a cellphone, a smartphone, a wearable device, or another similar computing apparatus. Herein the shown components, the connections and relationships between these components, and the functions of these components are illustrative only and are not intended to limit the implementation of the present disclosure as described and/or claimed herein.

As shown in FIG. 4, the device 400 includes a computing unit 401. The computing unit 401 may perform various types of appropriate operations and processing based on a computer program stored in a read-only memory (ROM) 402 or a computer program loaded from a storage unit 408 to a random-access memory (RAM) 403. Various programs and data required for operations of the device 400 may also be stored in the RAM 403. The computing unit 401, the ROM 402, and the RAM 403 are connected to each other through a bus 404. An input/output (I/O) interface 405 is also connected to the bus 404.

Multiple components in the device 400 are connected to the I/O interface 405. The multiple components include an input unit 406 such as a keyboard and a mouse, an output unit 407 such as various types of displays and speakers, the storage unit 408 such as a magnetic disk and an optical disk, and a communication unit 409 such as a network card, a modem and a wireless communication transceiver. The communication unit 409 allows the device 400 to exchange information/data with other devices over a computer network such as the Internet and/or over various telecommunication networks.

The computing unit 401 may be a general-purpose and/or special-purpose processing component having processing and computing capabilities. Examples of the computing unit 401 include, but are not limited to, a central processing unit (CPU), a graphics processing unit (GPU), a special-purpose artificial intelligence (AI) computing chip, a computing unit executing machine learning model algorithms, a digital signal processor (DSP), and any appropriate processor, controller and microcontroller. The computing unit 401 performs various methods and processing described above, such as the method for determining the line pressing state of a vehicle. For example, in some embodiments, the method for determining the line pressing state of a vehicle may be implemented as a computer software program tangibly contained in a machine-readable medium such as the storage unit 408. In some embodiments, part or all of computer programs may be loaded and/or installed on the device 400 via the ROM 402 and/or the communication unit 409. When the computer programs are loaded into the RAM 403 and executed by the computing unit 401, one or more steps of the preceding method for determining the line pressing state of a vehicle may be performed. Alternatively, in other embodiments, the computing unit 401 may be configured, in any other appropriate manner (for example, by means of firmware), to perform the method for determining the line pressing state of a vehicle.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a dedicated or general-purpose programmable processor for receiving data and instructions from a memory system, at least one input device and at least one output device and transmitting the data and instructions to the memory system, the at least one input device and the at least one output device.

Program codes for implementation of the methods of the present disclosure may be written in one programming language or any combination of multiple programming languages. These program codes may be provided for the processor or controller of a general-purpose computer, a special-purpose computer or another programmable data processing device to enable functions/operations specified in a flowchart and/or a block diagram to be implemented when the program codes are executed by the processor or controller. The program codes may be executed entirely on a machine or may be executed partly on a machine. As a stand-alone software package, the program codes may be executed partly on a machine and partly on a remote machine or may be executed entirely on a remote machine or a server.

In the context of the present disclosure, the machine-readable medium may be a tangible medium that may include or store a program used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on a computer. The computer has a display device for displaying information to the user, such as a cathode-ray tube (CRT) or a liquid-crystal display (LCD) monitor, and a keyboard and a pointing device such as a mouse or a trackball through which the user can provide input for the computer. Other types of apparatuses may also be used for providing interaction with the user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network, and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS).

It is to be understood that various forms of the preceding flows may be used with steps reordered, added, or removed. For example, the steps described in the present disclosure may be executed in parallel, in sequence, or in a different order as long as the desired results of the technical solutions disclosed in the present disclosure can be achieved. The execution sequence of these steps is not limited herein.

The scope of the present disclosure is not limited to the preceding embodiments. It is to be understood by those skilled in the art that various modifications, combinations, sub-combinations, and substitutions may be made according to design requirements and other factors.

Any modification, equivalent substitution, improvement, and the like made within the spirit and principle of the present disclosure fall within the scope of the present disclosure.

What is claimed is:

1. A method for determining a line pressing state of a vehicle, comprising:
determining a vehicle type of a target vehicle in a to-be-recognized image and a visible wheel region where a visible wheel of the target vehicle in the to-be-recognized image is located;
determining, according to the vehicle type and the visible wheel region, a blocked wheel region where a blocked wheel of the target vehicle in the to-be-recognized image is located; and
determining a line pressing state of the target vehicle according to the visible wheel region and the blocked wheel region.

2. The method according to claim 1, wherein determining, according to the vehicle type and the visible wheel region, the blocked wheel region where the blocked wheel of the target vehicle in the to-be-recognized image is located comprises:
determining, according to the vehicle type, a first relative pose between the visible wheel and the blocked wheel in a world coordinate system; and
determining the blocked wheel region according to the visible wheel region, the first relative pose, and camera parameter information of a target camera, wherein the target camera is a camera for collecting the to-be-recognized image.

3. The method according to claim 2, wherein determining the blocked wheel region according to the visible wheel region, the first relative pose, and the camera parameter information of the target camera comprises:
determining, according to the camera parameter information and the first relative pose, a second relative pose between the visible wheel and the blocked wheel in the to-be-recognized image; and
determining the blocked wheel region according to the second relative pose and the visible wheel region.

4. The method according to claim 3, wherein determining, according to the camera parameter information and the first relative pose, the second relative pose between the visible wheel and the blocked wheel in the to-be-recognized image comprises:
determining a matrix product between the camera parameter information and the first relative pose, and determining the second relative pose according to the matrix product.

5. The method according to claim 1, wherein determining the line pressing state of the target vehicle according to the visible wheel region and the blocked wheel region comprises:
determining a lane line region of a target lane line in the to-be-recognized image and, determining, according to the visible wheel region and the blocked wheel region, a wheel set region; and
matching wheel pixel coordinates in the wheel set region with lane pixel coordinates in the lane line region, and determining, according to a matching result, the line pressing state of the target vehicle.

6. The method according to claim 5, wherein determining, according to the matching result, the line pressing state of the target vehicle comprises:
in a case where at least one of the wheel pixel coordinates matches a lane pixel coordinate of the lane pixel coordinates, determining that the line pressing state of the target vehicle is a line pressed state.

7. An electronic device, comprising:
at least one processor; and
a memory communicatively connected to the at least one processor,
wherein the memory stores an instruction executable by the at least one processor, and the instruction is executed by the at least one processor to cause the at least one processor to perform:
determining a vehicle type of a target vehicle in a to-be-recognized image and a visible wheel region where a visible wheel of the target vehicle in the to-be-recognized image is located;
determining, according to the vehicle type and the visible wheel region, a blocked wheel region where a blocked wheel of the target vehicle in the to-be-recognized image is located; and
determining a line pressing state of the target vehicle according to the visible wheel region and the blocked wheel region.

8. The electronic device according to claim 7, wherein the instruction is executed by the at least one processor to cause the at least one processor to perform determining, according to the vehicle type and the visible wheel region, the blocked wheel region where the blocked wheel of the target vehicle in the to-be-recognized image is located in the following way:
determining, according to the vehicle type, a first relative pose between the visible wheel and the blocked wheel in a world coordinate system; and
determining the blocked wheel region according to the visible wheel region, the first relative pose, and camera parameter information of a target camera, wherein the target camera is a camera for collecting the to-be-recognized image.

9. The electronic device according to claim 8, wherein the instruction is executed by the at least one processor to cause the at least one processor to perform determining the blocked wheel region according to the visible wheel region, the first relative pose, and the camera parameter information of the target camera in the following way:
determining, according to the camera parameter information and the first relative pose, a second relative pose between the visible wheel and the blocked wheel in the to-be-recognized image; and
determining the blocked wheel region according to the second relative pose and the visible wheel region.

10. The electronic device according to claim 9, wherein the instruction is executed by the at least one processor to cause the at least one processor to perform determining, according to the camera parameter information and the first relative pose, the second relative pose between the visible wheel and the blocked wheel in the to-be-recognized image in the following way:
determining a matrix product between the camera parameter information and the first relative pose, and determining the second relative pose according to the matrix product.

11. The electronic device according to claim 7, wherein the instruction is executed by the at least one processor to cause the at least one processor to perform determining the line pressing state of the target vehicle according to the visible wheel region and the blocked wheel region in the following way:
determining a lane line region of a target lane line in the to-be-recognized image and, determining, according to the visible wheel region and the blocked wheel region, a wheel set region; and
matching wheel pixel coordinates in the wheel set region with lane pixel coordinates in the lane line region, and determining, according to a matching result, the line pressing state of the target vehicle.

12. The electronic device according to claim 11, wherein the instruction is executed by the at least one processor to cause the at least one processor to perform determining, according to the matching result, the line pressing state of the target vehicle in the following way:
in a case where at least one of the wheel pixel coordinates matches a lane pixel coordinate of the lane pixel coordinates, determining that the line pressing state of the target vehicle is a line pressed state.

13. A non-transitory computer-readable storage medium storing a computer instruction, wherein the computer instruction is configured to cause a computer to perform:
determining a vehicle type of a target vehicle in a to-be-recognized image and a visible wheel region where a visible wheel of the target vehicle in the to-be-recognized image is located;
determining, according to the vehicle type and the visible wheel region, a blocked wheel region where a blocked wheel of the target vehicle in the to-be-recognized image is located; and
determining a line pressing state of the target vehicle according to the visible wheel region and the blocked wheel region.

14. The non-transitory computer-readable storage medium according to claim 13, wherein the computer instruction is configured to cause the computer to perform determining, according to the vehicle type and the visible wheel region, the blocked wheel region where the blocked wheel of the target vehicle in the to-be-recognized image is located in the following way:
determining, according to the vehicle type, a first relative pose between the visible wheel and the blocked wheel in a world coordinate system; and
determining the blocked wheel region according to the visible wheel region, the first relative pose, and camera parameter information of a target camera, wherein the target camera is a camera for collecting the to-be-recognized image.

15. The non-transitory computer-readable storage medium according to claim 14, wherein the computer instruction is configured to cause the computer to perform determining the blocked wheel region according to the visible wheel region, the first relative pose, and the camera parameter information of the target camera in the following way:
determining, according to the camera parameter information and the first relative pose, a second relative pose between the visible wheel and the blocked wheel in the to-be-recognized image; and
determining the blocked wheel region according to the second relative pose and the visible wheel region.

16. The non-transitory computer-readable storage medium according to claim 15, wherein the computer instruction is configured to cause the computer to perform determining, according to the camera parameter information and the first relative pose, the second relative pose between the visible wheel and the blocked wheel in the to-be-recognized image in the following way:
determining a matrix product between the camera parameter information and the first relative pose, and determining the second relative pose according to the matrix product.

17. The non-transitory computer-readable storage medium according to claim 13, wherein the computer instruction is configured to cause the computer to perform determining the line pressing state of the target vehicle according to the visible wheel region and the blocked wheel region in the following way:
determining a lane line region of a target lane line in the to-be-recognized image and, determining, according to the visible wheel region and the blocked wheel region, a wheel set region; and
matching wheel pixel coordinates in the wheel set region with lane pixel coordinates in the lane line region, and determining, according to a matching result, the line pressing state of the target vehicle.

18. The non-transitory computer-readable storage medium according to claim 17, wherein the computer instruction is configured to cause the computer to perform determining, according to the matching result, the line pressing state of the target vehicle in the following way:
in a case where at least one of the wheel pixel coordinates matches a lane pixel coordinate of the lane pixel coordinates, determining that the line pressing state of the target vehicle is a line pressed state.
